(19) United States
(12) Patent Application Publication
(10) Pub. No.: US 2026/0342494 A1
(43) Pub. Date: Oct. 29, 2026

(54) LAYER CONTAINED MIMO MAPPING

(71) Applicant: QUALCOMM Incorporated, San Diego, CA (US)

(72) Inventors: Chih-Hao LIU, San Diego, CA (US); Tzu-Hsuan CHOU, San Diego, CA (US); Yu ZHANG, San Diego, CA (US); Jing SUN, San Diego, CA (US); Wei YANG, San Diego, CA (US); Kirill IVANOV, La Jolla, CA (US)

(21) Appl. No.: 19/192,234

(22) Filed: Apr. 28, 2025

(51) Int. Cl. H04L 5/00; H04B 7/0456; H04W 72/232

(52) U.S. Cl. CPC H04L 5/0037; H04B 7/0486; H04W 72/232

(57) ABSTRACT

A method for wireless communication at a user equipment (UE) and related apparatus are provided. In the method, the UE encodes an input signal to obtain an encoded signal including multiple code blocks. The multiple code blocks are sequentially mapped to multiple layers for communication between the UE and a network entity based on a layer mapping order. The multiple code blocks include one or more end code blocks and one or more non-end code blocks, and each of the one or more non-end code blocks is located in one layer of the multiple layers. The UE further transmits the encoded signal to the network entity via at least one layer of the multiple layers.

### TECHNICAL FIELD

The present disclosure relates generally to communication systems and, more particularly, to layer-contained multi-input-multi-output (MIMO) mapping in wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard, and some aspects of future wireless communication technologies may be based on aspects of 5G NR. There exists a need for further improvements in 5G NR technology and future wireless communication technologies, such as 6G, among other examples. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor may be configured to encode an input signal to obtain an encoded signal including multiple code blocks, where the multiple code blocks are sequentially mapped to multiple layers for communication between the UE and a network entity based on a layer mapping order, where the multiple code blocks include one or more end code blocks and one or more non-end code blocks, and where each of the one or more non-end code blocks is located in one layer of the multiple layers; and transmit, to the network entity via at least one layer of the multiple layers, the encoded signal.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor may be configured to encode an input signal to obtain an encoded signal including multiple code blocks, where the multiple code blocks are sequentially mapped to multiple layers for communication between a UE and the network entity based on a layer mapping order, where the multiple code blocks include one or more end code blocks and one or more non-end code blocks, and where each of the one or more non-end code blocks is located in one layer of the multiple layers; and transmit, to the UE via at least one layer of the multiple layers, the encoded signal.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of using a geometric mean decomposition (GMD) precoder to process a signal.

FIG. 5 is a diagram illustrating an example of spatially coupled multi-input multi-output (MIMO) layer mapping the enables the successive interference cancellation (SIC) across the code blocks.

FIG. 6 is a diagram illustrating an example of layer-contained (LC)-MIMO code block (CB) mapping in accordance with various aspects of the present disclosure.

FIG. 7A is a diagram illustrating an example of the delay on the SIC due to different numbers of resource elements (REs) in the CBs.

FIG. 7B is a diagram illustrating an example distribution of REs for CBs in accordance with various aspects of the present disclosure.

FIG. 8 is a diagram illustrating an example of the cross-layer mapping for an ending CB in accordance with various aspects of the present disclosure.

FIG. 9 is a call flow diagram illustrating a method of wireless communication in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a network entity in accordance with various aspects of the present disclosure.

FIG. 13 is a flowchart illustrating methods of wireless communication at a network entity in accordance with various aspects of the present disclosure.

FIG. 14 is a diagram illustrating an example of a hardware implementation for an example apparatus and/or UE.

FIG. 15 is a diagram illustrating an example of a hardware implementation for an example network entity.

### DETAILED DESCRIPTION

In wireless communication, a transmitter may map code blocks (CBs) to different layers (e.g., data streams) between the transmitter and the receiver. Techniques such as geometric mean decomposition (GMD) precoding in combination with decision feedback equalization (DFE) demapping may be used to equalize the signal-to-interference-plus-noise ratio (SINR) across these layers. In multi-input-multi-output (MIMO) communication that utilizes multiple layers, a single CB may be mapped to more than one layer in a staggered manner to exploit the diversity from different layers and facilitate successive interference cancellation (SIC) to reduce the cross-layer error propagation. In some examples, channel coding may be used to correct bit errors and reconstruct the quadrature amplitude modulation (QAM) symbol from the decoded bits, significantly reducing the cross-layer error propagation in the DFE demapper. However, enabling this approach may necessitate a new CB-to-layer mapping scheme to support it. Example aspects provide methods and apparatus for layer-contained codeword mapping for a precoder (e.g., GMD precoders), where the per-layer signal-to-noise ratios (SNRs) are equalized, and SIC is supported.

Various aspects relate generally to wireless communication. Some aspects more specifically relate to layer-contained multi-input-multi-output (MIMO) mapping in wireless communication. In some examples, a UE encodes an input signal to obtain an encoded signal including multiple code blocks. The multiple code blocks are sequentially mapped to multiple layers for communication between the UE and a network entity based on a layer mapping order, and the multiple code blocks include one or more end code blocks and one or more non-end code blocks. Each of the one or more non-end code blocks is located in one layer of the multiple layers. The UE further transmits the encoded signal to the network entity via at least one layer of the multiple layers. In some examples, the one or more non-end code blocks may include a set of non-end code blocks respectively located on the multiple layers with overlapping REs, and each of the set of non-end code blocks may occupy the same number of REs and may be located at the same RE location. In some examples, the UE may receive a precoding indicator for the GMD precoding on the input signal from the network entity via downlink control information (DCI), and the UE may apply the geometric mean decomposition (GMD) precoding on the input signal based on the precoding indicator. In some examples, the UE may receive a layer mapping indicator specifying the layer mapping order from the network entity via the DCI. In some examples, the one or more non-end code blocks may include a set of non-end code blocks respectively located on the multiple layers with overlapping resource elements (REs), and each earlier non-end code block in the set of non-end code blocks may occupy the same number of REs as, or one more RE than, each subsequent non-end code block in the set of non-end code blocks.

Particular aspects of the subject matter described in this disclosure can be implemented to realize one or more of the following potential advantages. In some examples, by confining each code block of an input signal to a single layer (except for ending CBs) during the layer mapping, the described techniques enable more reliable reconstruction of cross-layer interference and reduce error propagation that is common in demapping methods, thereby improving interference management in wireless communication. In some examples, by allowing cross-layer mapping for ending CBs and applying a backoff in modulation and coding scheme (MCS), the described techniques reduce the errors associated with rate mismatches or insufficient REs, thereby enhancing the robustness of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, 6G systems, or other communication systems, may be arranged in multiple manners with various components or constituent parts. As an example, in a wireless communication network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

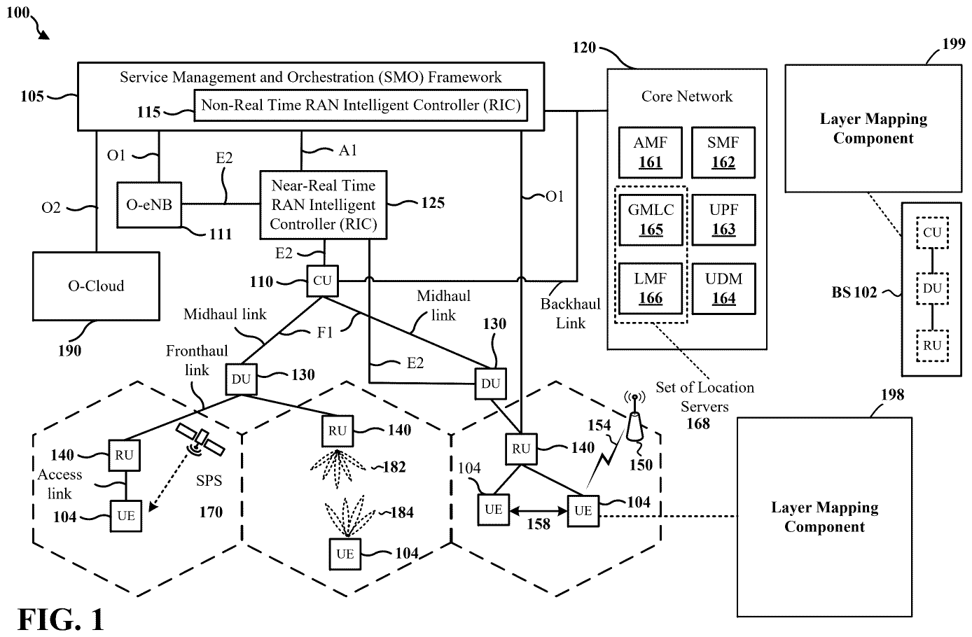

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. An operating band for these mid-band frequencies may have the frequency range designation FR3 (7.125 GHZ-24.25 GHZ), for example. Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation, or other wireless communication operation, beyond 52.6 GHz. For example, three higher operating bands have been identified as frequency range designations FR2-2 (52.6 GHz-71 GHz), FR4 (71 GHz-114.25 GHz), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the layer mapping component 198. The layer mapping component 198 may be configured to encode an input signal to obtain an encoded signal including multiple code blocks, where the multiple code blocks are sequentially mapped to multiple layers for communication between the UE and a network entity based on a layer mapping order, where the multiple code blocks include one or more end code blocks and one or more non-end code blocks, and where each of the one or more non-end code blocks is located in one layer of the multiple layers; and transmit, to the network entity via at least one layer of the multiple layers, the encoded signal. In certain aspects, the base station 102 may include the layer mapping component 199. The layer mapping component 199 may be configured to encode an input signal to obtain an encoded signal including multiple code blocks, where the multiple code blocks are sequentially mapped to multiple layers for communication between a UE and the network entity based on a layer mapping order, where the multiple code blocks include one or more end code blocks and one or more non-end code blocks, and where each of the one or more non-end code blocks is located in one layer of the multiple layers; and transmit, to the UE via at least one layer of the multiple layers, the encoded signal. Although the following description may be focused on 5G NR, the concepts described herein may be applicable to other similar areas, such as LTE, LTE-A, CDMA, GSM, and other wireless technologies.

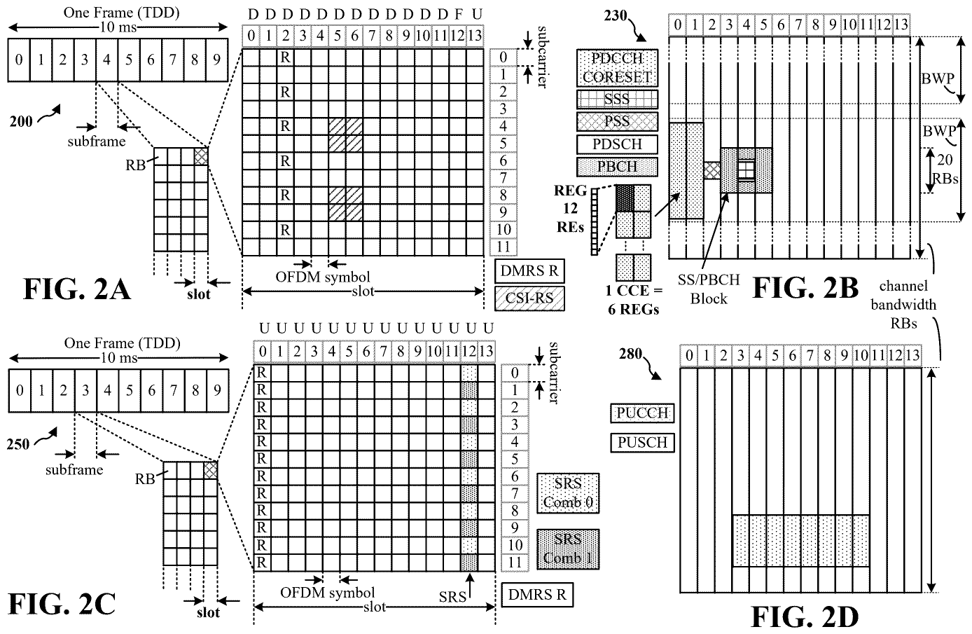

FIG. 2A is a diagram 200 illustrating an example of a first subframe within a 5G NR frame structure. The examples in FIGS. 2A-2D, illustrate aspects of a frame structure based on 5G NR to illustrate the concept of time and frequency resources based on a frame structure. Similar aspects may be used in connection with other technology, such as 6G, for example. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15 [kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

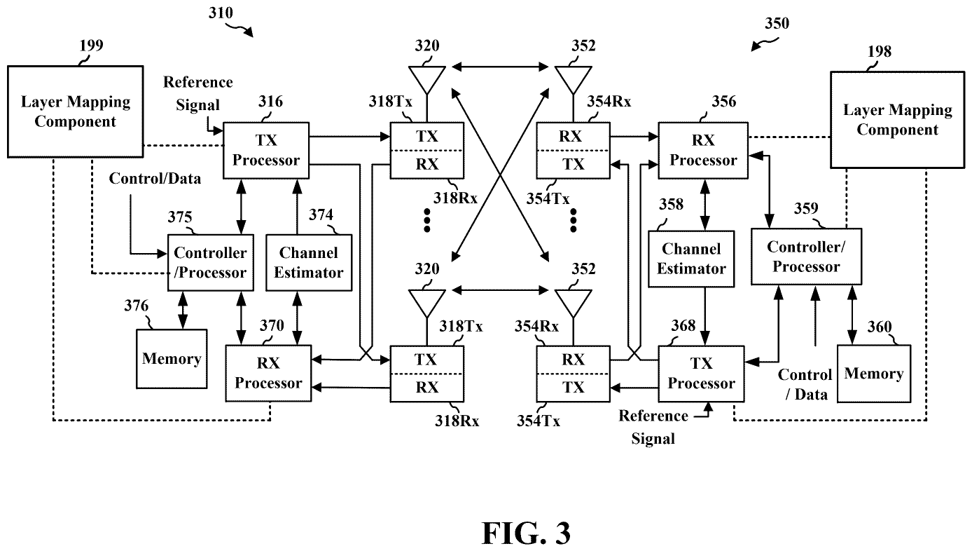

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the layer mapping component 198 of FIG. 1.

At least one of the TX processor 316, the RX processor 370, and the controller/processor 375 may be configured to perform aspects in connection with the layer mapping component 199 of FIG. 1.

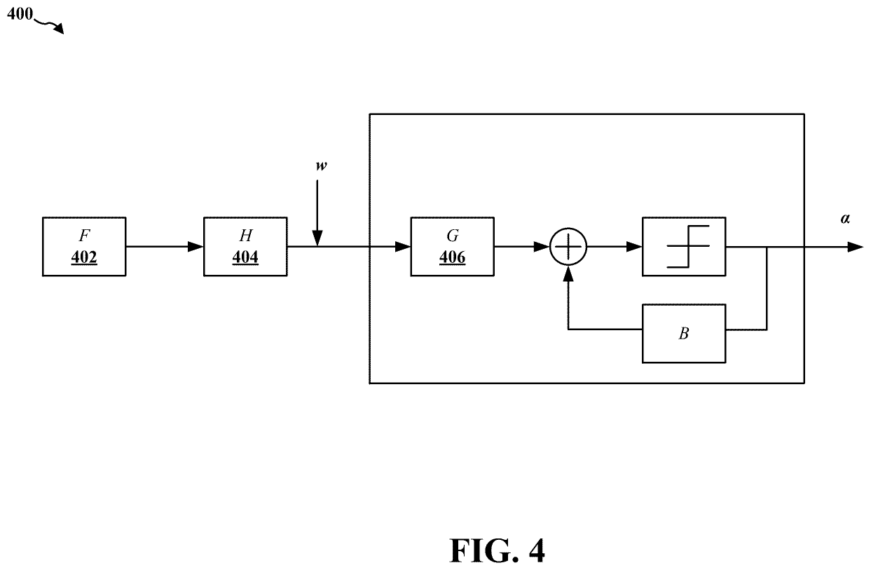

In wireless communication, a precoder and a corresponding demapper may be used to process the communication signal on the channel. In some examples, the precoder may be a zero forcing geometric mean decomposition (GMD) precoder, and the demapper may be a decision feedback equalization (DFE) demapper. FIG. 4 is a diagram 400 illustrating an example of using a GMD precoder to process a signal. As shown in FIG. 4, the GMD precoder F 402 may be applied on the channel between the transmitter and the receiver, where the channel matrix H (e.g., at 404) is:

H=QRP^{H}=QD_{R}(I+B)P^{H} (1)

In Equation (1), P and Q are semi-unitary matrices. The matrix R is an upper triangular matrix, expressed as: R=D_{R}(I+B), where D_{R} is a diagonal matrix with Rᵢᵢ on its diagonal. In some examples, the precoder F 402 may be set to P, and the feed forward equalizer G (e.g., at 406) is defined as:

$$G = {D}_{R}^{- 1} {Q}^{H} \qquad ( 2 )$$

In some examples, the GMD precoder may transform the system into multiple (e.g., M) independent scalar Gaussian channels, each having the same signal-to-noise ratio (SNR). In some examples, the GMD precoder has been shown to provide gains (e.g., a 4 dB gain) over the singular value decomposition (SVD) precoder in the high SNR region, as it rebalances the per-layer SNR across the multiple layers (e.g., data streams) between the transmitter and the receiver. In some examples, the GMD DFE transceivers may be used for multi-input multi-output (MIMO) communication, providing advantages such as minimizing arithmetic mean-square-error (MSR), minimizing the average bit error rate (BER) in high-SNR conditions, and approaching channel capacity by enabling the use of the same modulation and coding scheme (MCS) on each layer (e.g., data stream) in high-SNR conditions. Hence, the use of multiple transport blocks (TB) for transmission may not be necessary.

In MIMO communication that involves multiple layers (e.g., multiple MIMO layers), the codeword (CW) to MIMO layer mapping may adopt a single CW design with irregular low-density parity-check (LDPC) code. In some examples, to achieve better performance, non-linear MIMO demodulation techniques such as pre-selected reference signal decision (PSRD) or enhanced PSRD (ePSRD) may be utilized along with iterative demodulation and decoding across layers to approach channel capacity. In some examples, a multi-CW design may be used, along with a SIC receiver, to achieve channel capacity, provided that accurate per-layer modulation and coding scheme (MCS) and channel quality indicator (CQI) information are available.

In some examples, the codeword to MIMO layer mapping may be based on a single CW design that incorporates spatial coupling (meaning one code word is distributed or mapped across multiple layers). In this method, the single CW rate may be selected to match the collective channel quality across multiple layers. This facilitates SIC across code blocks (CBs) within the same transport block (TB) or codeword (CW). Each CB may be designed to span both interference-free layers and full-interference layers.

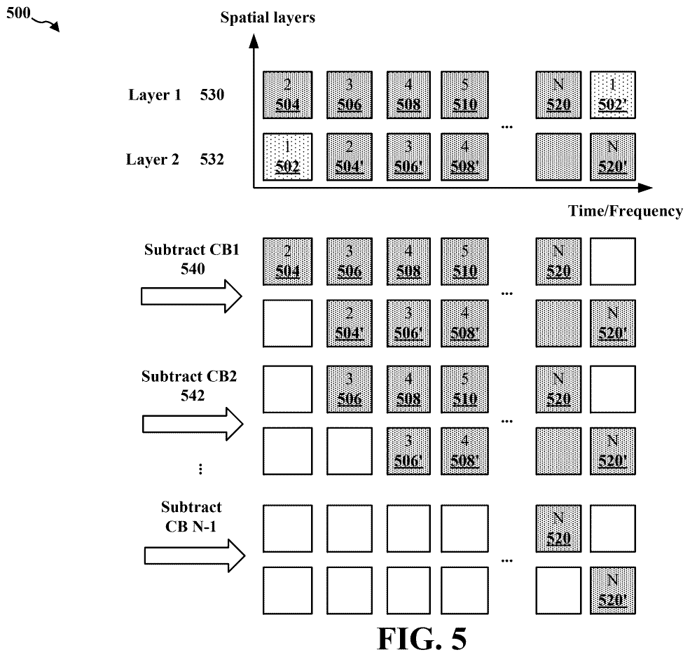

FIG. 5 is a diagram 500 illustrating an example of spatially coupled MIMO layer mapping the enables the SIC across the code blocks. As shown in FIG. 5, multiple code blocks (e.g., code block 1 502, 502′ code block 2 504, 504′, code block 3 506, 506′, code block 4 508, 508′, code block 5 510, 510′, through code block N 520, 520′) may be mapped to the MIMO layers (e.g., layer 1 530, layer 2 532). In the spatially coupled MIMO layer mapping shown in FIG. 5, a single CB may be mapped to more than one layer in a staggered manner to allow for SIC across the layers. For example, two portions of code block 2 (e.g., 504 and 504′) may respectively mapped to layer 1 530 and layer 2 532 in staggered time and/or frequency locations. Such a MIMO layer mapping may allow the SIC across the layers to reduce the error propagation across the layers. For example, as shown in FIG. 5, after code block 1 (e.g., 502) is successfully decoded, its contribution may be subtracted from the received signal (e.g., at 540), allowing subsequent decoding on code block 2 (e.g., 504, 504′) in sequence. Due to the staggered placements of the two parts of code block 2 (e.g., 504, 504′) on the two layers (e.g., layer 1 530, layer 2 532), cross-layer interference during decoding of code block 2 may be minimized.

Similarly, once the code block 2 (e.g., 504, 504′) has been decoded, its contribution may be subtracted from the received signal (e.g., at 542), and the decoding process may proceed to code block 3 (e.g., 506, 506′). This process may be repeated iteratively until all the code blocks have been decoded.

In some examples, the GMD DFE transceivers, which combine GMD precoding and DFE equalization, may be used to equalize the SINR across scheduled layers so that a single MCS applied uniformly across all layers may be able to achieve the channel capacity. In contrast, SVD precoding may need a matching MCS per layer to reach capacity.

However, for a larger number of layers, the DFE receiver may suffer from error propagation. To reduce the error propagation, a demapper (e.g., the DFE demapper) may use hard slicing of the log-likelihood ratios (LLRs) to reconstruct the QAM symbol from higher layer(s), followed by successive cancellation of the interference in the target lower layer.

In some examples, if there were a way to allow channel coding to correct the bit errors and reconstruct the QAM symbol from the decoded bits, the cross-layer error propagation in the DFE demapper may be greatly reduced. However, enabling this approach may necessitate a new CB-to-layer mapping scheme to support it. Example aspects provide methods and apparatus for layer-contained codeword mapping for a precoder (e.g., GMD precoders), where the per-layer SNRs are equalized and SIC is supported.

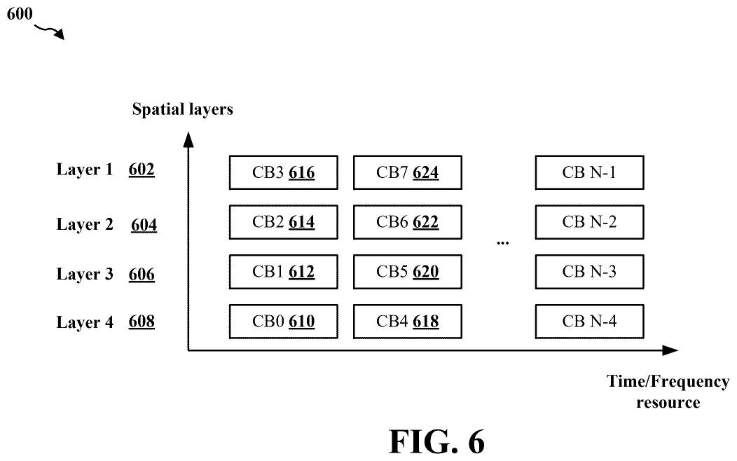

In some aspects, the GMD precoding and DFE receiver may be used to equalize the SNR of all the layers, eliminating the need to spread a code block (CB) across different layers. In this case, layer-contained (LC) MIMO (LC-MIMO) CB mapping enables the receiver to reconstruct the cross-layer interference much more reliably than by using hard slicing of the LLRs. This improved reconstruction helps to address and mitigate the issue of error propagation in the DFE demapper. FIG. 6 is a diagram 600 illustrating an example of LC-MIMO CB mapping in accordance with various aspects of the present disclosure. In the example of FIG. 6, the MIMO communication may involve four layers (e.g., layer 1 602, layer 2 604, layer 3 606, layer 4 608) between the transmitter and the receiver, and each CB may be mapped to a single layer. For example, CB 0 610 and CB 4 618 are mapped to layer 4 608, CB 1 612 and CB 5 620 are mapped to layer 3 606, CB 2 614 and CB 6 622 are mapped to layer 2 604, and CB 3 616 and CB 7 624 are mapped to layer 1 602.

In some aspects, the code blocks from a codeword, or transport block (TB), may be mapped to different layers following a predefined layer ordering. Each code block, except for the ending CBs, may be confined within a single layer. In some examples, the code blocks from a TB or codeword (CW) may be sequentially mapped to the layers in a repetitive manner according to the predefined layer order.

In some aspects, the predefined layer order may correspond to the layer decoding order used by the demapper (e.g., the GMD DFE demapper or DFE demapper). This approach ensures that the demodulator processes the code blocks sequentially from the smallest to the largest CB index, thereby maintaining the causality of SIC in the demapper (e.g., the DFE demapper). As a result, the performance of SIC does not need to wait for the decoding of later CBs. For example, referring to FIG. 6, the DFE demapper may decode from the last layer (e.g., layer 4 608) to the first layer (e.g., layer 1 602), so the CBs may be mapped sequentially from the fourth layer (e.g., layer 4 608) to the first layer (e.g., layer 1 605), and this pattern may be repeated. As an example, the first code block (e.g., code block 0 610) may be mapped to the fourth layer (e.g., layer 4 608), the second code block (e.g., code block 1 612) may be mapped to the third layer (e.g., layer 3 606), the third code block (e.g., code block 2 614) may be mapped to the second layer (e.g., layer 2 604), etc.

In some aspects, to ensure that the SIC of a CB (e.g., code block 0 610) in a given layer does not need to wait for the decoding of a later CB (e.g., code block 1 612), the size of the CBs may be aligned, except for the ending CBs.

In some aspects, all CBs, excluding the ending CBs, across layers with overlapping resource elements (REs), may occupy the same number of REs and the same RE locations within their respective layers. For example, in FIG. 6, the code blocks respectively mapped to the multiple layers, such as code block 0 610, code block 1 612, code block 2 614, code block 3 616, may correspond to overlapping REs. For example, these code blocks (e.g., code block 0 610, code block 1 612, code block 2 614, code block 3 616) may occupy the same number of REs and may be located at the same RE location in the respective layers. As used herein, a “precoder” refers to a component or entity that performs a precoding process (e.g., a transmitter-side operation that processes the to-be-transmitted information (e.g., QAM symbols) to modulated symbols), and a “demapper” refers to a component or entity that performs the demapping process (e.g., a receiver-side operation that processes the received modulated symbols to recover the original information bits). In some aspects, a GMD precoder may be used as an example of a precoder, and a GMD DFE demapper (or simply a DFE demapper) may be used as an example of a demapper. However, the principles disclosed herein are not limited to these specific types, and other types precoders or demappers may also be used. For examples, the demapper may be a CB based SIC demapper, and a precoding technique other than the GMD precoding may be used.

In some aspects, when the GMD precoding is applied by the transmitter, the transmitter may inform the receiver to use the GMD DFE demapper on the received signal. In some aspects, to avoid error propagation, the GMD CB mapping may be applied, and the application of the GMD CB mapping may be signaled. For example, the network may signal the UE to apply the GMD CB mapping for uplink signals.

In some aspects, for downlink communication, the base station may signal the UE to recommend the use of the GMD DFE demapper when GMD precoding is applied on the base station. For example, this signaling may be conveyed through the downlink control information (DCI) to indicate that GMD precoding is being used on the base station. In some aspects, for uplink communication, the base station may use the DCI to ask the UE to apply GMD precoding. In some aspects, the UE may choose to apply GMD precoding and the UE may indicate its use of the GMD precoding to the base station in the uplink control information (UCI).

In some aspects, the GMD CB to layer mapping may be signaled either independently from the GMD precoding indication, or jointly with it. That is, in some examples, the precoding indicator (indicating the GMD precoding) and the layer mapping indicator (indicating GMD CB to layer mapping) may be transmitted as separate indicators. In some examples, the precoding indicator (indicating the GMD precoding) and the layer mapping indicator (indicating GMD CB to layer mapping) may be transmitted in a single indicator.

In some aspects, DCI may be used to indicate the use of GMD CB to layer mapping. In some aspects, an independent field in the DCI may be used to indicate the new GMD CB to layer mapping. For example, this field could identify whether the CB to layer mapping follows the NR mapping, the SC-MIMO mapping, or the newly introduced GMD CB mapping. In some examples, this approach allows GMD precoding and GMD CB mapping to be turned on or off independently.

In some examples, when using DCI to indicate the use of GMD CB to layer mapping, the signaling may be jointly coded with the GMD precoding indication. In this case, GMD CB mapping will be turned on or off together with GMD precoding. In this case, a single bit in the DCI may be used to indicate the activation status of both the GMD precoder and the associated CB mapping.

In some aspects, the available resource elements (REs) may be evenly distributed among all the CBs within a TB, with the maximum difference between any two CBs being up to one RE, in order to ensure equal coding gain. In some examples, when the total number of REs cannot be evenly divided by the total number of CBs, the earlier part of the CBs may have a RE number (e.g., N⁻) that is one less than the RE number (e.g., N⁺) of the later part of the CBs.

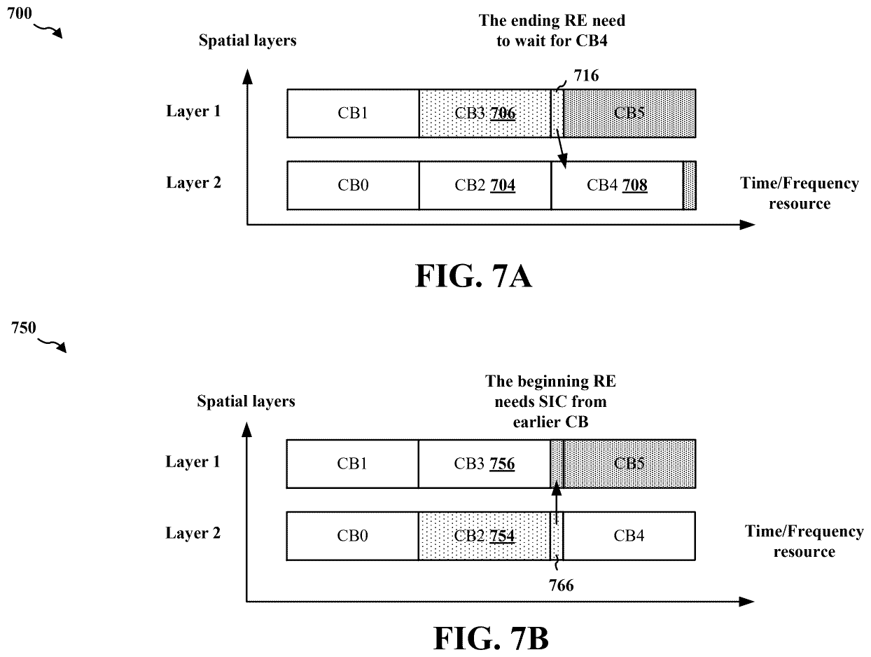

However, when applying such an RE distribution among CBs to GMD CB to layer mapping, SIC may have to wait for the decoding of a later CB after a switch from an earlier CB that contains fewer REs. FIG. 7A is a diagram 700 illustrating an example of the delay on the SIC due to different numbers of REs in the CBs. As shown in FIG. 7A, when the total number of REs cannot be evenly divided by the total number of CBs, the earlier part of the CBs (e.g., CB 2 704) may have one less RE (e.g., RE 716) than the later part of the CBs (e.g., CB 3 706). In this case, SIC on CB 3 706 may have to wait for the decoding of CB 4 708 after a switch from an earlier CB that contains fewer REs (e.g., CB 2 704).

Hence, for GMD CB mapping, to ensure that all CBs (except for the ending CBs) across layers use the same set of REs in their respective layers, a new method may be used to redistribute the CBs in the presence of an uneven number of REs. In some aspects, when the total number of REs per layer cannot be evenly divided by the number of CBs, the earlier part of the CBs may be assigned one more RE than the later part of the CBs. As mentioned above, aspects herein propose layer-contained codeword mapping (e.g., LC-MIMO) for GMD precoders as the per-layer SNRs may be the same (i.e., no benefit in a reference model (RM) across layers) and the SIC may be facilitated via the same.

FIG. 7B is a diagram 750 illustrating an example distribution of REs for CBs in accordance with various aspects of the present disclosure. As shown in FIG. 7B, when the total number of REs per layer cannot be evenly divided by the number of CBs, the earlier part of the CBs (e.g., CB 2 754) may be assigned one more RE (e.g., RE 766) than the later part of the CBs (e.g., CB 3 756).

In some aspects, the last one or more code blocks in a TB, with the number corresponding to mod (number of CBs, number of layers), where mod( ) represents the modular operation, may be referred to as the ending block. In some examples, there may not be enough remaining REs within a single layer for the ending code block(s). Therefore, cross-layer allocation is allowed for ending code block(s) to ensure proper rate matching. In some aspects, for the ending CBs, cross-layer CB mapping is permitted using the same predefined layer ordering for the non-ending CBs.

In some aspects, the number of ending CBs may correspond to the last mod (total number of CBs, number of layers) CBs. These ending CBs may be allowed to be rate matched across multiple layers when the remaining REs within the starting layer are not sufficient to accommodate all of the rate-matched symbols. In some examples, the cross-layer CB mapping may follow the same layer ordering for non-ending CBs. For example, the layer ordering for the ending CBs may align with the decoding order used by the DFE demapper.

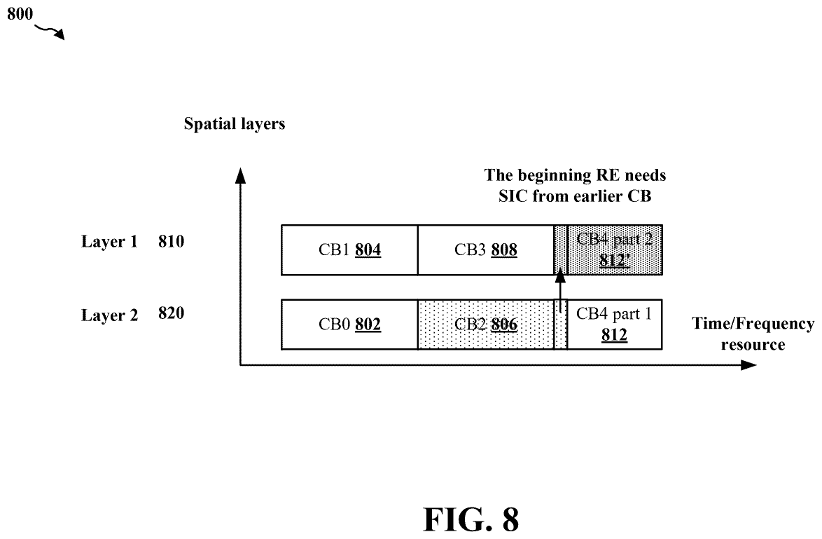

FIG. 8 is a diagram 800 illustrating an example of the cross-layer mapping for an ending CB in accordance with various aspects of the present disclosure. As shown in FIG. 8, there are not enough remaining REs within a single layer for the ending code block (e.g., code block 4 812, 812′). Therefore, cross-layer allocation is allowed for ending code block (e.g., code block 4 812, 812′) to ensure proper rate matching. For example, in FIG. 8, the first part of code block 4 (e.g., 812) is mapped to layer 2 820, while the second part of code block 4 (e.g., 812′) is mapped to layer 1 810. In some examples, the cross-layer CB mapping for the ending code block (e.g., code block 4 812, 812′) may follow the same layer ordering for non-ending CBs (e.g., code block 0 802, code block 1 804, code block 2 806, and code block 3 808), such as in the order of from layer 2 820 to layer 1 810.

In some aspects, the error propagation may be more pronounced on the ending code blocks (e.g., code block 4 812, 812′). To mitigate the error propagation, the receiver (e.g., UE for downlink signal) may implement a PSRD or a reduced complexity maximum likelihood (ML) demapper. In some examples, the receiver (e.g., UE for downlink signal) may treat the ending CBs as special CBs with a backoff MCS.

In some aspects, the ending CBs may be treated as special CBs with a backoff MCS. In some examples, the MCS of the ending CB may be reduced by a value denoted as δ(N_{RB}, N_{L}, MCS), which is smaller than the scheduled MCS. For example, the backoff value δ(N_{RB}, N_{L}, MCS) may be a function of several parameters, including the total resource block allocation (e.g., N_{RB}), the number of layers (e.g., N_{L}), the scheduling MCS (e.g., MCS), and the starting layer in the DFE demapper. In some examples, the closer the ending CB is to the starting layer of the DFE demapper, the more robust the MCS needs to be in order to prevent error propagation.

In some aspects, to resolve the issue of the total number of code blocks (CBs) not being a multiple of the number of layers, the total number of CBs may be set as a multiple of the number of layers during TB to CB segmentation. In some examples, the minimum number of CBs may be set to equal the number of layers, and the total number of CBs may be a multiple of the number of layers.

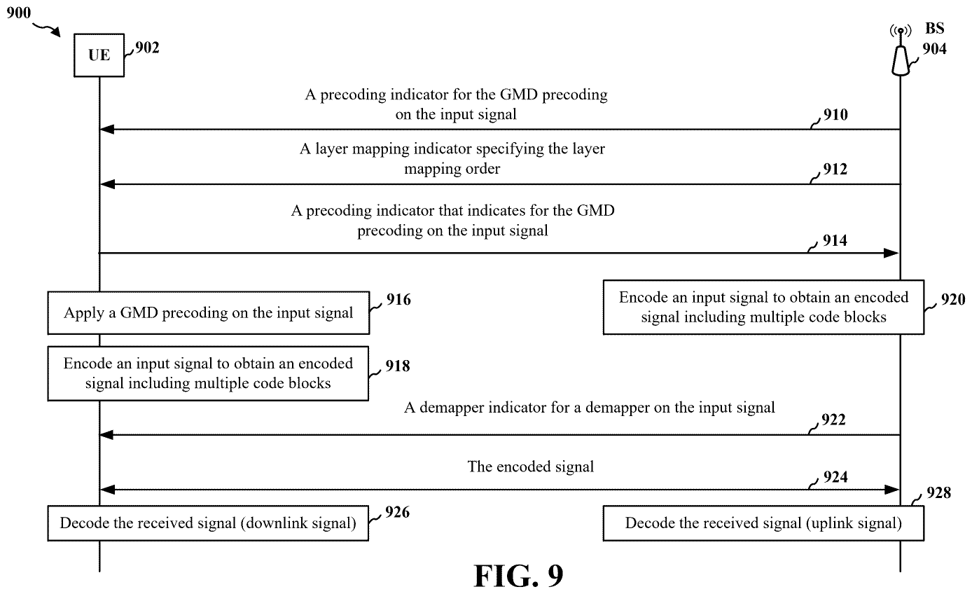

FIG. 9 is a call flow diagram 900 illustrating a method of wireless communication in accordance with various aspects of this present disclosure. Various aspects are described in connection with a UE 902 and a base station 904. The aspects may be performed by the UE 902 or the base station 904 in aggregation and/or by one or more components of a base station 904 (e.g., a CU 110, a DU 130, and/or an RU 140).

As shown in FIG. 9, at 910, the UE 902 may receive from base station 904 a precoding indicator for a precoding scheme on an input signal. As an example, the precoding indicator may indicate the UE to apply the geometric mean decomposition (GMD) precoding on the input signal. In some examples, the UE 902 may receive the precoding indicator from base station 904 via DCI.

At 912, the UE 902 may receive a layer mapping indicator specifying the layer mapping order for the UE 902. The UE 902 may apply the layer mapping order when encoding an input signal (e.g., at 918). In some examples, the UE 902 may receive the layer mapping indicator via DCI.

In some examples, the UE 902 may receive the precoding indicator (e.g., at 910) and the layer mapping indicator (e.g., at 912) from base station 904 via separate indicators (e.g., separated DCI). In some examples, the UE 902 may receive the precoding indicator and the layer mapping indicator via a combined indicator (e.g., single DCI that includes the precoding indicator and the layer mapping indicator).

In some examples, the UE 902 may inform the base station 904 of the precoding methods (e.g., the GMD precoding) it uses on an uplink signal. For example, the UE 902 may, at 914, transmit to the base station via uplink control information (UCI), a precoding indicator that indicates the precoding method (e.g., the GMD precoding) on the input signal.

At 916, the UE 902 may apply the GMD precoding on the input signal.

At 918, the UE 902 may encode an input signal (e.g., an uplink signal) to obtain an encoded signal including multiple code blocks. During this process, the multiple code blocks may be sequentially mapped to multiple layers for communication between the UE 902 and base station 904 based on a layer mapping order (e.g., the layer mapping order received at 912). In some examples, the multiple code blocks may include one or more end code blocks and one or more non-end code blocks, and each of the one or more non-end code blocks may be located in one layer of the multiple layers.

At 924, the UE 902 may transmit the encoded signal to base station 904.

Upon receiving the encoded signal, the base station 904 may decode the received signal at 928. For example, the base station 904 may apply a layer decoding order to decode the received signal. For example, the layer decoding order may correspond to the layer mapping order the UE 902 used to encode the input signal at 918.

In some examples, the base station 904 may utilize the code blocks mapping scheme described in 918 when encoding a downlink signal. For example, at 920, the base station 904 may encode an input signal (e.g., a downlink signal) to obtain an encoded signal including multiple code blocks. The multiple code blocks may be sequentially mapped to multiple layers for communication between UE 902 and the base station 904 based on a layer mapping order. For example, the multiple code blocks may include one or more end code blocks and one or more non-end code blocks, and each of the one or more non-end code blocks is located in one layer of the multiple layers.

In some examples, at 922, the base station 904 may transmit to the UE 902, via DCI, a demapper indicator for a demapper (e.g., the GMD DFE demapper) on the input signal, as an example. The demapper indicator allows the UE 902 to apply the correct layer decoding order to process the received downlink signal. For example, the layer decoding order may correspond to the layer mapping order the base station 904 used to encode the downlink signal at 920.

At 924, the base station 904 may transmit the encoded signal to the UE 902.

At 926, upon receiving the signal from base station 904, the UE 902 may Decode the received signal (downlink signal). For example, the UE 902 may apply a layer decoding order to decode the received signal. For example, the layer decoding order may correspond to the layer mapping order the base station 904 used to encode the input signal at 920.

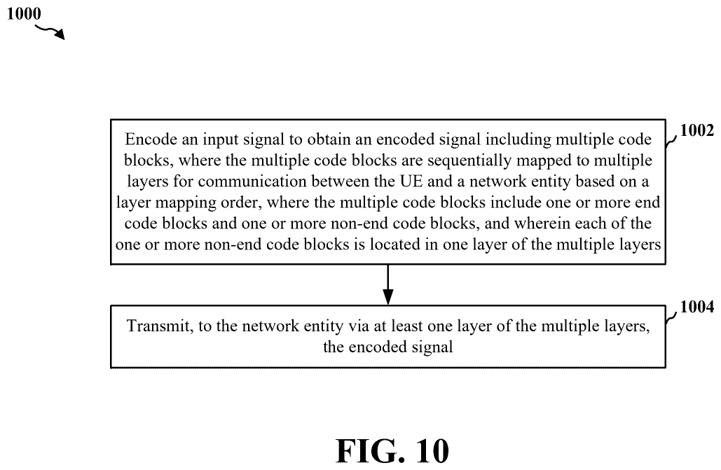

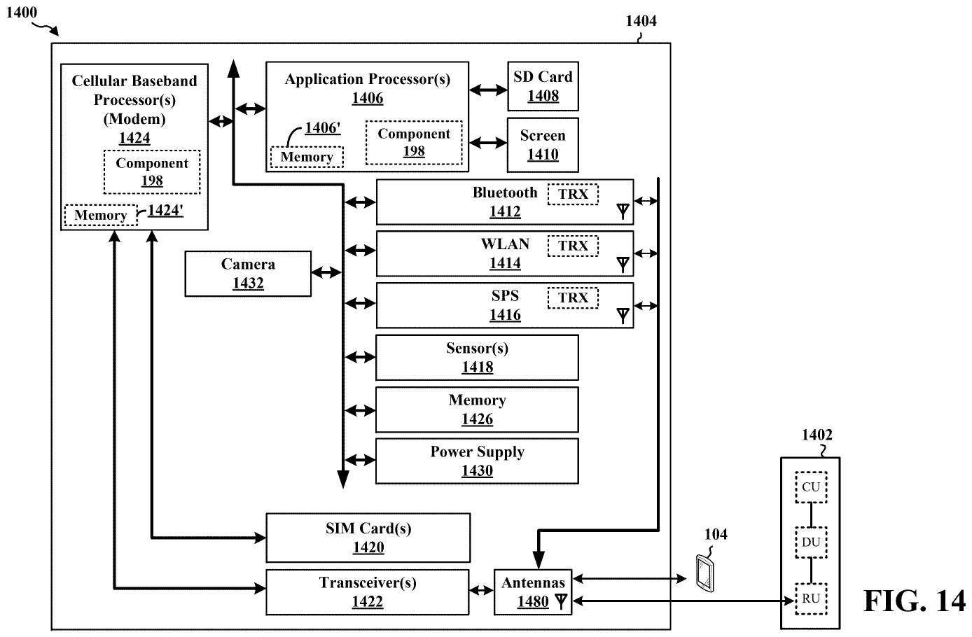

FIG. 10 is a flowchart 1000 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 904; or the network entity 1402 in the hardware implementation of FIG. 14). The UE may be the UE 104, 350, 902, or the apparatus 1404 in the hardware implementation of FIG. 14. By confining each code block of an input signal to a single layer (except for ending CBs) during the layer mapping, the methods enable more reliable reconstruction of cross-layer interference and reduce error propagation that is common in demapping methods, thereby improving interference management in wireless communication. Additionally, by allowing cross-layer mapping for ending CBs and applying a backoff in MCS, the methods reduce the errors associated with rate mismatches or insufficient REs, thereby enhancing the robustness of wireless communication.

As shown in FIG. 10, at 1002, the UE may encode an input signal to obtain an encoded signal including multiple code blocks. The multiple code blocks may be sequentially mapped to multiple layers for communication between the UE and a network entity based on a layer mapping order. The multiple code blocks may include one or more end code blocks and one or more non-end code blocks, and each of the one or more non-end code blocks may be located in one layer of the multiple layers. FIG. 6, FIG. 7B, FIG. 8, and FIG. 9 illustrate various aspects of the steps in connection with flowchart 1000. For example, referring to FIG. 9, the UE 902 may, at 918, encode an input signal to obtain an encoded signal including multiple code blocks. The multiple code blocks may be sequentially mapped to multiple layers for communication between the UE 902 and a network entity (e.g., base station 904) based on a layer mapping order. The multiple code blocks may include one or more end code blocks and one or more non-end code blocks, and each of the one or more non-end code blocks may be located in one layer of the multiple layers. In some aspects, 1002 may be performed by the layer mapping component 198.

At 1004, the UE may transmit the encoded signal to the network entity via at least one layer of the multiple layers. For example, referring to FIG. 9, the UE 902 may, at 924, transmit the encoded signal to the network entity (e.g., base station 904) via at least one layer of the multiple layers. In some aspects, 1004 may be performed by the layer mapping component 198.

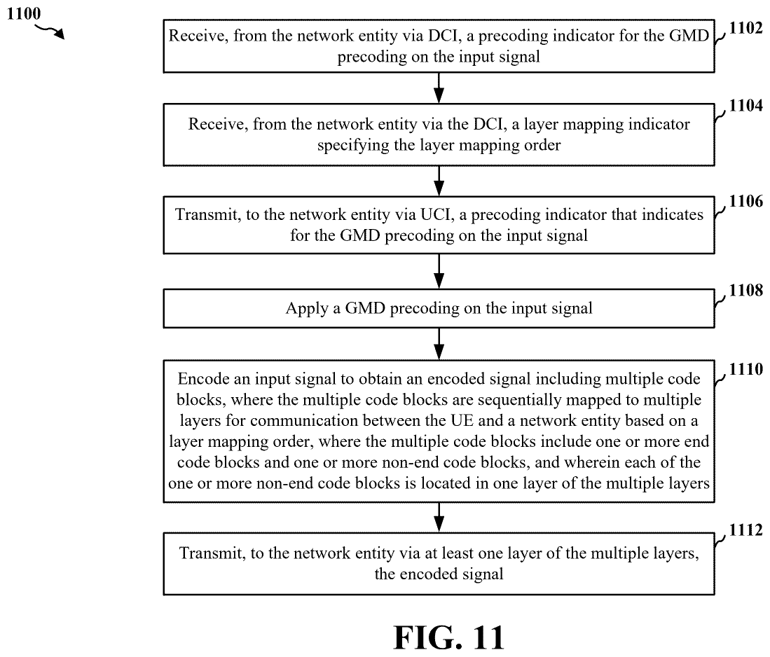

FIG. 11 is a flowchart 1000 illustrating methods of wireless communication at a UE in accordance with various aspects of the present disclosure. The method may be performed by a UE in collaboration with a network entity. The network entity may be a base station, or a component of a base station, in the access network of FIG. 1 or a core network component (e.g., base station 102, 310, 904; or the network entity 1402 in the hardware implementation of FIG. 14). The UE may be the UE 104, 350, 902, or the apparatus 1404 in the hardware implementation of FIG. 14. By confining each code block of an input signal to a single layer (except for ending CBs) during the layer mapping, the methods enable more reliable reconstruction of cross-layer interference and reduce error propagation that is common in demapping methods, thereby improving interference management in wireless communication. Additionally, by allowing cross-layer mapping for ending CBs and applying a backoff in MCS, the methods reduce the errors associated with rate mismatches or insufficient REs, thereby enhancing the robustness of wireless communication.

As shown in FIG. 11, at 1110, the UE may encode an input signal to obtain an encoded signal including multiple code blocks. The multiple code blocks may be sequentially mapped to multiple layers for communication between the UE and a network entity based on a layer mapping order. The multiple code blocks may include one or more end code blocks and one or more non-end code blocks, and each of the one or more non-end code blocks may be located in one layer of the multiple layers. FIG. 6, FIG. 7B, FIG. 8, and FIG. 9 illustrate various aspects of the steps in connection with flowchart 1100. For example, referring to FIG. 9, the UE 902 may, at 918, encode an input signal to obtain an encoded signal including multiple code blocks. The multiple code blocks may be sequentially mapped to multiple layers for communication between the UE 902 and a network entity (e.g., base station 904) based on a layer mapping order. The multiple code blocks may include one or more end code blocks and one or more non-end code blocks, and each of the one or more non-end code blocks may be located in one layer of the multiple layers. In some aspects, 1010 may be performed by the layer mapping component 198.

At 1112, the UE may transmit the encoded signal to the network entity via at least one layer of the multiple layers. For example, referring to FIG. 9, the UE 902 may, at 924, transmit the encoded signal to the network entity (e.g., base station 904) via at least one layer of the multiple layers. In some aspects, 1112 may be performed by the layer mapping component 198.

In some aspects, the layer mapping order may be based on a layer decoding order for a demapper at the network entity. For example, referring to FIG. 6, the layer mapping order may be based on a layer decoding order for a demapper (e.g., the GMD DFE demapper) at the network entity (e.g., base station 904). For example, the layer mapping order may be from layer 4 608, to layer 3 606, to layer 2 604, and to layer 1 602.

In some aspects, the one or more non-end code blocks may include a set of non-end code blocks respectively located on the multiple layers with overlapping resource elements (REs). Each of the set of non-end code blocks may occupy the same number of REs and may be located at the same RE location. For example, referring to FIG. 6, the one or more non-end code blocks may include a set of non-end code blocks (e.g., code block 0 610, code block 1 612, code block 2 614, code block 3 616) respectively located on the multiple layers (e.g., layer 4 610, layer 3 606, layer 2 604, layer 1 602) with overlapping REs. Each of the set of non-end code blocks may occupy the same number of REs and may be located at the same RE location.

In some aspects, at 1108, the UE may apply the GMD precoding on the input signal. For example, referring to FIG. 9, the UE 902 may, at 916, apply the GMD precoding on the input signal. In some aspects, 1108 may be performed by the layer mapping component 198.

In some aspects, at 1102, the UE may receive, from the network entity via downlink control information (DCI), a precoding indicator for the GMD precoding on the input signal. The UE may apply the GMD precoding on the input signal (e.g., at 1108) based on the precoding indicator. For example, referring to FIG. 9, the UE 902 may, at 910, receive, from the network entity (e.g., base station 904) via DCI, a precoding indicator for the GMD precoding on the input signal. The UE may apply the GMD precoding on the input signal (e.g., at 916) based on the precoding indicator. In some aspects, 1102 may be performed by the layer mapping component 198.

In some aspects, at 1104, the UE may receive from the network entity via the DCI a layer mapping indicator specifying the layer mapping order. For example, referring to FIG. 9, the UE 902 may, at 912, receive from the network entity (e.g., base station 904) via the DCI a layer mapping indicator specifying the layer mapping order. In some aspects, 1104 may be performed by the layer mapping component 198.

In some aspects, the precoding indicator and the layer mapping indicator may be provided as separate indicators. For example, referring to FIG. 9, the precoding indicator (e.g., at 910) and the layer mapping indicator (e.g., at 912) may be provided as separate indicators.

In some aspects, the precoding indicator and the layer mapping indicator may be combined into a single indicator. For example, referring to FIG. 9, the precoding indicator (e.g., at 910) and the layer mapping indicator (e.g., at 912) may be combined into a single indicator.

In some aspects, at 1106, the UE may transmit, to the network entity via UCI, a precoding indicator that indicates the GMD precoding on the input signal. For example, referring to FIG. 9, the UE 902 may, at 914, transmit, to the network entity (e.g., base station 904) via UCI, a precoding indicator that indicates the GMD precoding on the input signal. In some aspects, 1106 may be performed by the layer mapping component 198.

In some aspects, the one or more non-end code blocks may include a set of non-end code blocks respectively located on the multiple layers with overlapping resource elements (REs). Each earlier non-end code block in the set of non-end code blocks may occupy the same number of REs as, or one more RE than, each subsequent non-end code block in the set of non-end code blocks. For example, referring to FIG. 7B, the one or more non-end code blocks may include a set of non-end code blocks respectively located on the multiple layers with overlapping REs. Each earlier non-end code block (e.g., code block 2 754) in the set of non-end code blocks may occupy the same number of REs as, or one more RE (e.g., RE 766) than, each subsequent non-end code block (e.g., code block 3 756) in the set of non-end code blocks.

In some aspects, one end code block in the one or more end code blocks may be located on two or more layers of the multiple layers. For example, referring to FIG. 8, one end code block (e.g., code block 4 812, 812′) in the one or more end code blocks may be located on two or more layers (e.g., layer 1 810, layer 2 820) of the multiple layers.

In some aspects, the mapping of the one end code block on the two or more layers of the multiple layers is based on a layer decoding order for the demapper at the network entity. For example, referring to FIG. 8, the mapping of the one end code block (e.g., code block 4 812, 812′) on the two or more layers (e.g., layer 1 810, layer 2 820) of the multiple layers is based on a layer decoding order for the demapper (e.g., the GMD DFE demapper) at the network entity.

In some aspects, the one or more end code blocks may be associated with a first MCS, and the first MCS may be less than a scheduled MCS. For example, referring to FIG. 8, the one or more end code blocks (e.g., code block 4 812, 812′) may be associated with a first MCS, and the first MCS may be less than a scheduled MCS (e.g., MCS for code block 0 802).

In some aspects, the difference between the first MCS and the scheduled MCS may be based on one or more of: the total number of RBs allocation, the number of layers in the multiple layers, the scheduled MCS, or the starting layer of a demapper at the network entity. For example, referring to FIG. 8, the difference between the first MCS (e.g., MCS for code block 4 812, 812′) and the scheduled MCS (e.g., MCS for code block 0 802) may be based on one or more of: the total number of RBs allocation, the number of layers (e.g., two layers including layer 1 810 and layer 2 820) in the multiple layers, the scheduled MCS, or the starting layer of a demapper at the network entity.

In some aspects, the first number of code blocks in the multiple code blocks may be greater than or equal to the second number of layers in the multiple layers, and the first number may be an integer multiplication of the second number. For example, referring to FIG. 8, the first number of code blocks (e.g., five code blocks) in the multiple code blocks may be greater than or equal to the second number of layers (e.g., two layers) in the multiple layers. Referring to FIG. 6, in some examples, the first number of code blocks (e.g., N) may be an integer multiplication of the second number of layers (e.g., four layers).

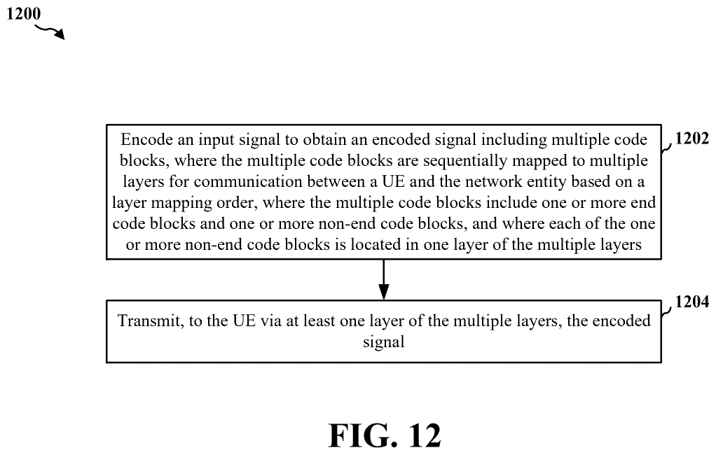

FIG. 12 is a flowchart 1200 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 904; or the network entity 1402 in the hardware implementation of FIG. 14). The UE may be the UE 104, 350, 902, or the apparatus 1404 in the hardware implementation of FIG. 14. By confining each code block of an input signal to a single layer (except for ending CBs) during the layer mapping, the methods enable more reliable reconstruction of cross-layer interference and reduce error propagation that is common in demapping methods, thereby improving interference management in wireless communication. Additionally, by allowing cross-layer mapping for ending CBs and applying a backoff in MCS, the methods reduce the errors associated with rate mismatches or insufficient REs, thereby enhancing the robustness of wireless communication.

As shown in FIG. 12, at 1202, the network entity may encode an input signal to obtain an encoded signal including multiple code blocks. The multiple code blocks may be sequentially mapped to multiple layers for communication between a UE and the network entity based on a layer mapping order. The multiple code blocks may include one or more end code blocks and one or more non-end code blocks, and each of the one or more non-end code blocks is located in one layer of the multiple layers. FIG. 6, FIG. 7B, FIG. 8, and FIG. 9 illustrate various aspects of the steps in connection with flowchart 1200. For example, referring to FIG. 9, the network entity (e.g., base station 904) may, at 920, encode an input signal to obtain an encoded signal including multiple code blocks. The multiple code blocks may be sequentially mapped to multiple layers for communication between a UE 902 and the network entity (e.g., base station 904) based on a layer mapping order. The multiple code blocks may include one or more end code blocks and one or more non-end code blocks, and each of the one or more non-end code blocks is located in one layer of the multiple layers. In some aspects, 1202 may be performed by the layer mapping component 199.

At 1204, the network entity may transmit, to the UE via at least one layer of the multiple layers, the encoded signal. For example, referring to FIG. 9, the network entity (e.g., base station 904) may, at 924, transmit, to the UE 902 via at least one layer of the multiple layers, the encoded signal. In some aspects, 1204 may be performed by the layer mapping component 199.

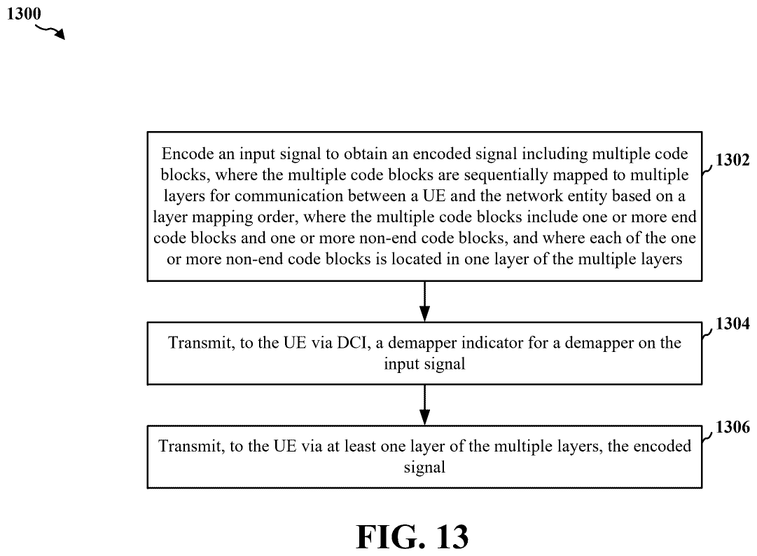

FIG. 13 is a flowchart 1300 illustrating methods of wireless communication at a network entity in accordance with various aspects of the present disclosure. The method may be performed by a network entity in collaboration with a UE. The network entity may be a base station, or a component of a base station, in the access network of FIG. 1 or a core network component (e.g., base station 102, 310, 904; or the network entity 1402 in the hardware implementation of FIG. 14). The UE may be the UE 104, 350, 902, or the apparatus 1404 in the hardware implementation of FIG. 14. By confining each code block of an input signal to a single layer (except for ending CBs) during the layer mapping, the methods enable more reliable reconstruction of cross-layer interference and reduce error propagation that is common in demapping methods, thereby improving interference management in wireless communication. Additionally, by allowing cross-layer mapping for ending CBs and applying a backoff in MCS, the methods reduce the errors associated with rate mismatches or insufficient REs, thereby enhancing the robustness of wireless communication.

As shown in FIG. 13, at 1302, the network entity may encode an input signal to obtain an encoded signal including multiple code blocks. The multiple code blocks may be sequentially mapped to multiple layers for communication between a UE and the network entity based on a layer mapping order. The multiple code blocks may include one or more end code blocks and one or more non-end code blocks, and each of the one or more non-end code blocks is located in one layer of the multiple layers. FIG. 6, FIG. 7B, FIG. 8, and FIG. 9 illustrate various aspects of the steps in connection with flowchart 1300. For example, referring to FIG. 9, the network entity (e.g., base station 904) may, at 920, encode an input signal to obtain an encoded signal including multiple code blocks. The multiple code blocks may be sequentially mapped to multiple layers for communication between a UE 902 and the network entity (e.g., base station 904) based on a layer mapping order. The multiple code blocks may include one or more end code blocks and one or more non-end code blocks, and each of the one or more non-end code blocks is located in one layer of the multiple layers. In some aspects, 1302 may be performed by the layer mapping component 199.

At 1306, the network entity may transmit, to the UE via at least one layer of the multiple layers, the encoded signal. For example, referring to FIG. 9, the network entity (e.g., base station 904) may, at 924, transmit, to the UE 902 via at least one layer of the multiple layers, the encoded signal. In some aspects, 1306 may be performed by the layer mapping component 199.

In some aspects, the layer mapping order may be based on a layer decoding order for the demapper at the UE. For example, referring to FIG. 9, the layer mapping order may be based on a layer decoding order for the demapper (e.g., the GMD DFE demapper) at the UE 902.

In some aspects, the one or more non-end code blocks may include a set of non-end code blocks respectively located on the multiple layers with overlapping REs. Each of the set of non-end code blocks may occupy the same number of REs and may be located at the same RE location. For example, referring to FIG. 8, the one or more non-end code blocks may include a set of non-end code blocks (e.g., code block 0 802, code block 1 804, code block 2 806, code block 3 808) respectively located on the multiple layers (e.g., layer 1 810, layer 2 820) with overlapping REs. Each of the set of non-end code blocks (e.g., code block 0 802, code block 1 804, code block 2 806, code block 3 808) may occupy the same number of REs and may be located at the same RE location.

In some aspects, at 1304, the network entity may transmit, to the UE via DCI, a demapper indicator for the demapper on the input signal. For example, referring to FIG. 9, the network entity (e.g., base station 904) may, at 922, transmit, to the UE 902 via DCI, a demapper indicator for the demapper (e.g., the GMD DFE demapper) on the input signal. In some aspects, 1304 may be performed by the layer mapping component 199.

In some aspects, the DCI may further indicate an application of a GMD precoding on the input signal on the network entity. For example, referring to FIG. 9, the DCI (e.g., at 922) may further indicate an application of a GMD precoding on the input signal on the network entity (e.g., base station 904).

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor (or processing circuitry) 1424 (also referred to as a modem) coupled to one or more transceivers 1422 (e.g., cellular RF transceiver). The cellular baseband processor(s) (or processing circuitry) 1424 may include at least one on-chip memory (or memory circuitry) 1424′. In some aspects, the apparatus 1404 may further include one or more subscriber identity modules (SIM) cards 1420 and at least one application processor (or processing circuitry) 1406 coupled to a secure digital (SD) card 1408 and a screen 1410. The application processor(s) (or processing circuitry) 1406 may include on-chip memory (or memory circuitry) 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) (or processing circuitry) 1424 communicates through the transceiver(s) 1422 via one or more antennas 1480 with the UE 104 and/or with an RU associated with a network entity 1402. The cellular baseband processor(s) (or processing circuitry) 1424 and the application processor(s) (or processing circuitry) 1406 may each include a computer-readable medium/memory (or memory circuitry) 1424′, 1406′, respectively. The additional memory modules 1426 may also be considered a computer-readable medium/memory (or memory circuitry). Each computer-readable medium/memory (or memory circuitry) 1424′, 1406′, 1426 may be non-transitory. The cellular baseband processor(s) (or processing circuitry) 1424 and the application processor(s) (or processing circuitry) 1406 are each responsible for general processing, including the execution of software stored on the computer-readable medium/memory (or memory circuitry). The software, when executed by the cellular baseband processor(s) (or processing circuitry) 1424/application processor(s) (or processing circuitry) 1406, causes the cellular baseband processor(s) (or processing circuitry) 1424/application processor(s) (or processing circuitry) 1406 to perform the various functions described supra. The cellular baseband processor(s) (or processing circuitry) 1424 and the application processor(s) (or processing circuitry) 1406 are configured to perform the various functions described supra based at least in part of the information stored in the memory (or memory circuitry). That is, the cellular baseband processor(s) (or processing circuitry) 1424 and the application processor(s) (or processing circuitry) 1406 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1424/application processor(s) (or processing circuitry) 1406 when executing software. The cellular baseband processor(s) (or processing circuitry) 1424/application processor(s) (or processing circuitry) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) (or processing circuitry) 1424 and/or the application processor(s) (or processing circuitry) 1406, and in another configuration, the apparatus 1404 may be the entire UE (e.g., see UE 350 of FIG. 3) and include the additional modules of the apparatus 1404.

As discussed supra, the component 198 may be configured to encode an input signal to obtain an encoded signal including multiple code blocks, where the multiple code blocks are sequentially mapped to multiple layers for communication between the UE and a network entity based on a layer mapping order, where the multiple code blocks include one or more end code blocks and one or more non-end code blocks, and where each of the one or more non-end code blocks is located in one layer of the multiple layers; and transmit, to the network entity via at least one layer of the multiple layers, the encoded signal. The component 198 may be further configured to perform any of the aspects described in connection with the flowcharts in FIG. 10 and FIG. 11, and/or performed by the UE 902 in FIG. 9. The component 198 may be within the cellular baseband processor(s) (or processing circuitry) 1424, the application processor(s) (or processing circuitry) 1406, or both the cellular baseband processor(s) (or processing circuitry) 1424 and the application processor(s) (or processing circuitry) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) (or processing circuitry) 1424 and/or the application processor(s) (or processing circuitry) 1406, includes means for encoding an input signal to obtain an encoded signal including multiple code blocks, where the multiple code blocks are sequentially mapped to multiple layers for communication between the UE and a network entity based on a layer mapping order, where the multiple code blocks include one or more end code blocks and one or more non-end code blocks, and where each of the one or more non-end code blocks is located in one layer of the multiple layers; and means for transmitting, to the network entity via at least one layer of the multiple layers, the encoded signal. The apparatus 1404 may further include means for performing any of the aspects described in connection with the flowcharts in FIG. 10 and FIG. 11, and/or aspects performed by the UE 902 in FIG. 9. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

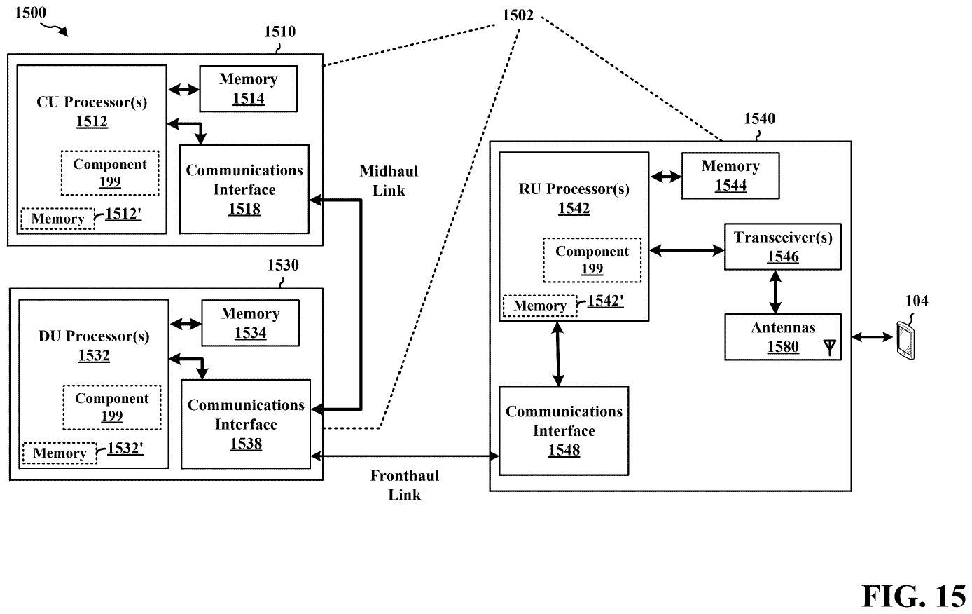

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor (or processing circuitry) 1512. The CU processor(s) (or processing circuitry) 1512 may include on-chip memory (or memory circuitry) 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor (or processing circuitry) 1532. The DU processor(s) (or processing circuitry) 1532 may include on-chip memory (or memory circuitry) 1532′. In some aspects, the DU 1530 may further include additional memory modules 1534 and a communications interface 1538. The DU 1530 communicates with the RU 1540 through a fronthaul link. The RU 1540 may include at least one RU processor (or processing circuitry) 1542. The RU processor(s) (or processing circuitry) 1542 may include on-chip memory (or memory circuitry) 1542′. In some aspects, the RU 1540 may further include additional memory modules 1544, one or more transceivers 1546, antennas 1580, and a communications interface 1548. The RU 1540 communicates with the UE 104. The on-chip memory (or memory circuitry) 1512′, 1532′, 1542′ and the additional memory modules 1514, 1534, 1544 may each be considered a computer-readable medium/memory (or memory circuitry). Each computer-readable medium/memory (or memory circuitry) may be non-transitory. Each of the processors (or processing circuitry) 1512, 1532, 1542 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to encode an input signal to obtain an encoded signal including multiple code blocks, where the multiple code blocks are sequentially mapped to multiple layers for communication between a UE and the network entity based on a layer mapping order, where the multiple code blocks include one or more end code blocks and one or more non-end code blocks, and where each of the one or more non-end code blocks is located in one layer of the multiple layers; and transmit, to the UE via at least one layer of the multiple layers, the encoded signal. The component 199 may be further configured to perform any of the aspects described in connection with the flowcharts in FIG. 12 and FIG. 13, and/or performed by the base station 904 in FIG. 9. The component 199 may be within one or more processors (or processing circuitry) of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 includes means for encoding an input signal to obtain an encoded signal including multiple code blocks, where the multiple code blocks are sequentially mapped to multiple layers for communication between a UE and the network entity based on a layer mapping order, where the multiple code blocks include one or more end code blocks and one or more non-end code blocks, and where each of the one or more non-end code blocks is located in one layer of the multiple layers; and means for transmitting, to the UE via at least one layer of the multiple layers, the encoded signal. The network entity 1502 may further include means for performing any of the aspects described in connection with the flowcharts in FIG. 12 and FIG. 13, and/or aspects performed by the base station 904 in FIG. 9. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include encoding an input signal to obtain an encoded signal including multiple code blocks, where the multiple code blocks are sequentially mapped to multiple layers for communication between the UE and a network entity based on a layer mapping order, where the multiple code blocks include one or more end code blocks and one or more non-end code blocks, and where each of the one or more non-end code blocks is located in one layer of the multiple layers; and transmitting, to the network entity via at least one layer of the multiple layers, the encoded signal. By confining each code block of an input signal to a single layer (except for ending CBs) during the layer mapping, the methods enable more reliable reconstruction of cross-layer interference and reduce error propagation that is common in demapping methods, thereby improving interference management in wireless communication. Additionally, by allowing cross-layer mapping for ending CBs and applying a backoff in MCS, the methods reduce the errors associated with rate mismatches or insufficient REs, thereby enhancing the robustness of wireless communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processor P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE). The method includes encoding an input signal to obtain an encoded signal including multiple code blocks, wherein the multiple code blocks are sequentially mapped to multiple layers for communication between the UE and a network entity based on a layer mapping order, wherein the multiple code blocks include one or more end code blocks and one or more non-end code blocks, and wherein each of the one or more non-end code blocks is located in one layer of the multiple layers; and transmitting, to the network entity via at least one layer of the multiple layers, the encoded signal.

Aspect 2 is the method of aspect 1, wherein the layer mapping order is based on a layer decoding order for a demapper at the network entity.

Aspect 3 is the method of any of aspects 1 to 2, wherein the one or more non-end code blocks include a set of non-end code blocks respectively located on the multiple layers with overlapping resource elements (REs), wherein each of the set of non-end code blocks occupies a same number of REs and is located at a same RE location.

Aspect 4 is the method of any of aspects 1 to 3, where the method further includes applying a geometric mean decomposition (GMD) precoding on the input signal.

Aspect 5 is the method of aspect 4, where the method further includes receiving, from the network entity via downlink control information (DCI), a precoding indicator for the GMD precoding on the input signal, wherein applying the GMD precoding on the input signal comprises applying, based on the precoding indicator, the GMD precoding on the input signal.

Aspect 6 is the method of aspect 5, where the method further includes receiving, from the network entity via the DCI, a layer mapping indicator specifying the layer mapping order.

Aspect 7 is the method of aspect 6, wherein the precoding indicator and the layer mapping indicator are provided as separate indicators.

Aspect 8 is the method of aspect 6, wherein the precoding indicator and the layer mapping indicator are combined into a single indicator.

Aspect 9 is the method of aspect 4, where the method further includes transmitting, to the network entity via uplink control information (UCI), a precoding indicator that indicates the GMD precoding on the input signal.

Aspect 10 is the method of any of aspects 1 to 9, wherein the one or more non-end code blocks include a set of non-end code blocks respectively located on the multiple layers with overlapping resource elements (REs), wherein each earlier non-end code block in the set of non-end code blocks occupies a same number of REs as, or one more RE than, each subsequent non-end code block in the set of non-end code blocks.

Aspect 11 is the method of any of aspects 1 to 9, wherein one end code block in the one or more end code blocks is located on two or more layers of the multiple layers.

Aspect 12 is the method of aspect 11, wherein a mapping of the one end code block on the two or more layers of the multiple layers is based on a layer decoding order for a demapper at the network entity.

Aspect 13 is the method of aspect 11, wherein the one or more end code blocks are associated with a first modulation and coding scheme (MCS), wherein the first MCS is less than a scheduled MCS.

Aspect 14 is the method of aspect 13, wherein a difference between the first MCS and the scheduled MCS is based on one or more of: a total number of resource blocks (RBs) allocation; a number of layers in the multiple layers; the scheduled MCS; or a starting layer of a demapper at the network entity.

Aspect 15 is the method of any of aspects 1 to 9, wherein a first number of code blocks in the multiple code blocks is greater than or equal to a second number of layers in the multiple layers, and wherein the first number is an integer multiplication of the second number.

Aspect 16 is an apparatus for wireless communication at a UE, comprising: at least one memory; and at least one processor coupled to the at least one memory, the at least one processor is configured to perform the method of any of aspects 1 to 15.

Aspect 17 is the apparatus for wireless communication at a UE, comprising means for performing each step in the method of any of aspects 1-15.

Aspect 18 is an apparatus of any of aspects 16-17, further comprising a transceiver configured to receive or to transmit in association with the method of any of aspects 1-15.

Aspect 19 is a computer-readable medium (e.g., a non-transitory computer-readable medium) storing computer executable code at a UE, the code when executed by at least one processor causes the at least one processor to perform the method of any of aspects 1-15.

Aspect 20 is a method of wireless communication at a network entity. The method includes encoding an input signal to obtain an encoded signal including multiple code blocks, wherein the multiple code blocks are sequentially mapped to multiple layers for communication between a user equipment (UE) and the network entity based on a layer mapping order, wherein the multiple code blocks include one or more end code blocks and one or more non-end code blocks, and wherein each of the one or more non-end code blocks is located in one layer of the multiple layers; and transmitting, to the UE via at least one layer of the multiple layers, the encoded signal.

Aspect 21 is the method of aspect 20, wherein the layer mapping order is based on a layer decoding order for a demapper at the UE.

Aspect 22 is the method of any of aspects 20 to 21, wherein the one or more non-end code blocks include a set of non-end code blocks respectively located on the multiple layers with overlapping resource elements (REs), wherein each of the set of non-end code blocks occupies a same number of REs and is located at a same RE location.

Aspect 23 is the method of any of aspects 20 to 22, where the method further includes transmitting, to the UE via downlink control information (DCI), a demapper indicator for a demapper on the input signal.

Aspect 24 is the method of aspect 23, wherein the DCI further indicates an application of a GMD precoding on the input signal on the network entity.

Aspect 25 is an apparatus for wireless communication at a network entity, comprising: at least one memory; and at least one processor coupled to the at least one memory and, where the at least one processor is configured to perform the method of any of aspects 20-24.

Aspect 26 is the apparatus for wireless communication at a network entity, comprising means for performing each step in the method of any of aspects 20-24.

Aspect 27 is an apparatus of any of aspects 25-26, further comprising a transceiver configured to receive or to transmit in association with the method of any of aspects 20-24.

Aspect 28 is a computer-readable medium (e.g., a non-transitory computer-readable medium) storing computer executable code at a network entity, the code when executed by at least one processor causes the at least one processor to perform the method of any of aspects 20-24.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
encode an input signal to obtain an encoded signal including multiple code blocks, wherein the multiple code blocks are sequentially mapped to multiple layers for communication between the UE and a network entity based on a layer mapping order, wherein the multiple code blocks include one or more end code blocks and one or more non-end code blocks, and wherein each of the one or more non-end code blocks is located in one layer of the multiple layers; and
transmit, to the network entity via at least one layer of the multiple layers, the encoded signal.

2. The apparatus of claim 1, further comprising a transceiver coupled to the at least one processor, wherein to transmit the encoded signal, the at least one processor is configured to transmit the encoded signal via the transceiver, wherein the layer mapping order is based on a layer decoding order for a demapper at the network entity.

3. The apparatus of claim 1, wherein the one or more non-end code blocks include a set of non-end code blocks respectively located on the multiple layers with overlapping resource elements (REs), wherein each of the set of non-end code blocks occupies a same number of REs and is located at a same RE location.

4. The apparatus of claim 1, wherein the at least one processor is further configured to:
apply a geometric mean decomposition (GMD) precoding on the input signal.

5. The apparatus of claim 4, wherein the at least one processor is further configured to:
receive, from the network entity via downlink control information (DCI), a precoding indicator for the GMD precoding on the input signal, wherein to apply the GMD precoding on the input signal, the at least one processor is configured to:
apply, based on the precoding indicator, the GMD precoding on the input signal.

6. The apparatus of claim 5, wherein the at least one processor is further configured to:
receive, from the network entity via the DCI, a layer mapping indicator specifying the layer mapping order.

7. The apparatus of claim 6, wherein the precoding indicator and the layer mapping indicator are provided as separate indicators.

8. The apparatus of claim 6, wherein the precoding indicator and the layer mapping indicator are combined into a single indicator.

9. The apparatus of claim 4, wherein the at least one processor is further configured to:
transmit, to the network entity via uplink control information (UCI), a precoding indicator that indicates the GMD precoding on the input signal.

10. The apparatus of claim 1, wherein the one or more non-end code blocks include a set of non-end code blocks respectively located on the multiple layers with overlapping resource elements (REs), wherein each earlier non-end code block in the set of non-end code blocks occupies a same number of REs as, or one more RE than, each subsequent non-end code block in the set of non-end code blocks.

11. The apparatus of claim 1, wherein one end code block in the one or more end code blocks is located on two or more layers of the multiple layers.

12. The apparatus of claim 11, wherein a mapping of the one end code block on the two or more layers of the multiple layers is based on a layer decoding order for a demapper at the network entity.

13. The apparatus of claim 11, wherein the one or more end code blocks are associated with a first modulation and coding scheme (MCS), wherein the first MCS is less than a scheduled MCS.

14. The apparatus of claim 13, wherein a difference between the first MCS and the scheduled MCS is based on one or more of:
a total number of resource blocks (RBs) allocation,
a number of layers in the multiple layers,
the scheduled MCS, or
a starting layer of a demapper at the network entity.

15. The apparatus of claim 1, wherein a first number of code blocks in the multiple code blocks is greater than or equal to a second number of layers in the multiple layers, and wherein the first number is an integer multiplication of the second number.

16. An apparatus for wireless communication at a network entity, comprising:
at least one memory; and
at least one processor coupled to the at least one memory and, based at least in part on information stored in the at least one memory, the at least one processor is configured to:
encode an input signal to obtain an encoded signal including multiple code blocks, wherein the multiple code blocks are sequentially mapped to multiple layers for communication between a user equipment (UE) and the network entity based on a layer mapping order, wherein the multiple code blocks include one or more end code blocks and one or more non-end code blocks, and wherein each of the one or more non-end code blocks is located in one layer of the multiple layers; and
transmit, to the UE via at least one layer of the multiple layers, the encoded signal.

17. The apparatus of claim 16, further comprising a transceiver coupled to the at least one processor, wherein to transmit the encoded signal, the at least one processor is configured to transmit the encoded signal via the transceiver, wherein the layer mapping order is based on a layer decoding order for a demapper at the UE.

18. The apparatus of claim 16, wherein the one or more non-end code blocks include a set of non-end code blocks respectively located on the multiple layers with overlapping resource elements (REs), wherein each of the set of non-end code blocks occupies a same number of REs and is located at a same RE location.

19. The apparatus of claim 16, wherein the at least one processor is further configured to:
transmit, to the UE via downlink control information (DCI), a demapper indicator for a demapper on the input signal.

20. A method of wireless communication at a user equipment (UE), comprising:
encoding an input signal to obtain an encoded signal including multiple code blocks, wherein the multiple code blocks are sequentially mapped to multiple layers for communication between the UE and a network entity based on a layer mapping order, wherein the multiple code blocks include one or more end code blocks and one or more non-end code blocks, and wherein each of the one or more non-end code blocks is located in one layer of the multiple layers; and
transmitting, to the network entity via at least one layer of the multiple layers, the encoded signal.
